(19) United States
(12) Patent Application Publication
(10) Pub. No.: US 2025/0174736 A1
(43) Pub. Date: May 29, 2025

(54) ELECTROCHEMICAL CELLS AND ELECTROLYTE COMPOSITIONS THEREFOR

(71) Applicant: Purdue Research Foundation, West Lafayette, IN (US)

(72) Inventors: Vilas Ganpat Pol, West Lafayette, IN (US); Hari Vignesh Ramasamy, Pollachi, Coimbatore, Tamil Nadu (IN)

(21) Appl. No.: 18/840,658

(22) PCT Filed: Feb. 24, 2023
(86) PCT No.: PCT/US2023/013830

§ 371 Date: Aug. 22, 2024

Related U.S. Application Data
(60) Provisional application No. 63/314,376, filed on Feb. 26, 2022.

(51) Int. Cl. H01M 10/42; H01M 4/02; H01M 4/485; H01M 10/0568

(52) U.S. Cl. CPC H01M 10/4235; H01M 4/485; H01M 10/0568; H01M 2004/027; H01M 2300/0025

(57) ABSTRACT

Electrochemical cells and electrolyte compositions therefor. Such an electrolyte composition includes lithium bifluorosulphonyl imide (LiFSI) dissolved in cyclopentyl methyl ether (CPME) solvent. The electrolyte composition has an anion-derived solvation structure that can form a lithium fluoride (LiF) layer on an anode of an electrochemical cell. The anion-derived solvation structure may reduce the covalent bond strength between the Li cations and FSI anions.

### BACKGROUND OF THE INVENTION

The present invention generally relates to electrochemical cells and electrolyte compositions capable of use in electrochemical cells.

Due to drastic shift towards renewable energy sources, like wind, solar, etc., the use of energy storage devices has become ubiquitous and useful in storing excess energy when generated and releasing such excess energy at a later time when needed for use. Lithium-ion batteries have a huge market share due to their high energy density, light weight, long cyclability and zero memory effect. State-of-the-art lithium-ion batteries (LIBs) comprise a layered oxide cathode, a graphite anode, and a carbonate-based electrolyte. Graphite anodes are attractive due to their relatively low cost, high capacity, and long cycle life.

The widespread application of LIBs in defense and space applications exposes them to ultralow temperatures, e.g., below 0° C., in applications such as electric vehicles (EV), unmanned aerial vehicles (UAV), submarines, space stations, etc., which may cause them to fail to deliver the required electrical capacity. Further the requirement of fast charging batteries that could reach 80% capacity in fifteen minutes as per USABC (The United States Advanced Battery Consortium) standards is a major advancement needed in the development of the next generation of LIBs. Among many other factors, the electrolyte (also referred to herein as electrolyte composition) of an LIB plays an important role in the development of LIBs that exhibit improved performance. The electrolyte dictates the bulk electrolyte conductivity and the formation of a solid electrolyte interface (SEI) layer, the two main factors responsible for efficiency and long term cyclability. During the initial charging, Li⁺ ions are deintercalated from the cathode and travel through the electrolyte. In the electrolyte, the Li⁺ ions are surrounded by solvent molecules forming a solvation structure in which the solvent molecules form a primary solvation sheath around each Li⁺ ion. When these solvated Li⁺ ions reach the graphite surface of the anode, they are stripped of their solvation sheath (desolvated) before intercalating into the layers of the anode. The quicker the desolvation process, the better is its charge transfer kinetics at low temperature and high current rates. Simultaneously, the solvent molecules are reduced on the anode surface and form the insulating SEI layer. This Li⁺ desolvation and migration at the anode-electrolyte interface remains the main bottleneck in achieving improved low temperature performance.

The electrolyte solvent participating in the solvation structure determines the nature of the SEI layer. Much electrolyte-related research has been focused on improving the physical properties of the SEI layer by adding small quantities of additives and cosolvents to improve overall electrochemical properties. Conventional carbonate electrolytes mainly contain 1M lithium hexafluorophosphate (LiPF₆) salt dissolved in highly polar solvents like ethylene carbonate (EC), propylene carbonate (PC), diethyl carbonate (DEC), etc. As used in this disclosure, M represents the molarity of the solution when used in similar contexts. The salt is dissociated into Li⁺ ions (cations) and PF₆⁻ ions (anions), and the solvent molecules form the solvation sheath around the Li⁺ ions. Due to its high polarity, the solvent is tightly bounded to the Li⁺ cations and primarily reduced during the initial formation cycles of the SEI layer, whereas the PF₆⁻ anions do not participate in this process. The solvent-derived SEI layer, which is porous and organic-rich, that forms on the graphite surface remains indispensable over time to prevent solvent co-intercalation and further exfoliation of graphite layers and provides good cyclability at room temperature (e.g., about 20 to 25° C.). When the temperature is slightly reduced, however, this chemistry struggles to adapt to the changes, which results in poor performance. Hence, it would be desirable to modify the internal chemistry to overcome this problem.

Moreover, the low temperature and fast charging of commercial LIBs are affected by other factors, including low conductivity of the electrolyte, higher charge transfer resistance at the electrode/electrolyte interface, high viscosity of solvents, and higher freezing point, for example. External approaches, such as battery thermal management system (BTMS) monitors and maintaining the temperature of battery packs with the help of heaters, coolers, and other additional accessories, are not efficient and add cost to the battery pack by sacrificing its volumetric energy density. To address these issues, several inner engineering approaches have been reported in the literature, such as making binary, ternary, and quaternary solvent mixtures with suitable properties to extend the liquid temperature range, or using functional additives to modify the SEI layer. Although these strategies may improve the low temperature operation to a certain extent, the source of the issue remains, the primary culprit being EC solvents freeze even at room temperature, which makes it difficult for low temperature operations. Hence, EC-free electrolyte compositions have been actively studied more recently, but with limited success so far.

Recently, high concentration electrolyte compositions, in which the ratio of the salt is increased with respect to the solvent, have been reported as alternative chemistries. In such situations, solvent deprivation leads to participation of the fluorine-containing PF₆⁻ anions in the solvation structure. In this state, in addition to the solvent molecules, contact ion pairs (CIPs) and cation and anion aggregates (AGG) prevail. The resulting change in the Fermi level causes a reduction of anion species on the anode surface followed by a reduction of solvent molecules. This creates a robust LiF-rich inorganic SEI layer with good performance. However, this technique has drawbacks, such as high cost, high viscosity, inferior wettability, low ionic conductivity, and poor low temperature performance. Diluting this high concentration electrolyte has been reported using a non-solvating diluent to reduce viscosity and prevent solvent co-intercalation of electrolyte at −20° C. Unfortunately, the reported process was very complex and provided only a small improvement of low temperature performance. Hence, a single-solvent solution would be desirable that was capable of encompassing necessary properties. Another reported study using isaxazole as a main solvent for a graphite anode demonstrated sufficient capacity even at −30° C., but stability was compromised. A further reported study developed 1,4-dioxane as a weakly solvated electrolyte to modify the SEI layer. However, the solubility of the solvent was very low and showed lower long-term stability without EC.

In view of the above, there continues to be an unmet need for modification of the internal chemistry of lithium ion batteries (and the electrochemical cells thereof) to improve their cycling performance at temperatures below room temperature.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, electrochemical cells, for example, electrochemical cells of Li-ion batteries, and to electrolyte compositions capable of use in electrochemical cells.

According to one nonlimiting aspect of the invention, an electrochemical cell includes an anode, a cathode, a separator, and an electrolyte contacting the anode, the cathode, and the separator. The electrolyte composition includes lithium bifluorosulphonyl imide (LiFSI) dissolved in cyclopentyl methyl ether (CPME) to form Li cations and FSI anions. The electrolyte composition has an anion-derived solvation structure that reduces the covalent bond strength between the Li cations and FSI anions. In some arrangements, the electrolyte composition does not include ethylene carbonate.

According to another nonlimiting aspect of the invention, an electrolyte composition for use in an electrochemical cell includes lithium bifluorosulphonyl imide (LiFSI) dissolved in cyclopentyl methyl ether (CPME). The electrolyte composition has an anion-derived solvation structure that can form a lithium fluoride (LiF) layer on an anode of an electrochemical cell. The anion-derived solvation structure may reduce the covalent bond strength between the Li cations and FSI anions.

Technical aspects of electrolyte compositions as described above preferably include the ability to improve the performance of an electrochemical cell of a lithium-ion battery when cycled at low temperatures (e.g., below 0° C. to about −40° C.).

These and other aspects, arrangements, features, and/or technical effects will become apparent upon detailed inspection of the figures and the following description.

### BRIEF DESCRIPTION OF DRAWINGS

FIG. 1 is a schematic representation of solvation structures present in a conventional (“commercial”) electrolyte of ethylene carbonate and diethyl carbonate (EC:DEC) in a 1:1 volume ratio in which 1M lithium hexafluorophosphate (LiPF₆) salt has been dissolved, solvation structures present in an experimental electrolyte containing cyclopentyl methyl ether (CPME) in which 1M lithium bifluorosulphonyl imide (LiFSI) has been dissolved, and their respective impacts on SEI formation in an electrochemical cell of a lithium ion battery according to certain nonlimiting aspects of the present invention.

FIG. 2A shows Raman spectra of a commercial electrolyte containing 1M LiFSI dissolved in dimethoxyethane (DME) and two experimental electrolytes containing 1M or 5M LiFSI dissolved in CPME.

FIG. 2B shows deconvoluted spectra of FSI⁻ anions in solvation structures of the three electrolyte compositions of FIG. 2A.

FIG. 2C is a schematic representation of solvation structures of the three electrolyte compositions of FIGS. 2A and 2B.

FIG. 3A shows results of a room temperature study of the discharge capacity-voltage curves at 0.1 C-rate between 0.001V and 1.5 V for a commercial 1:1 EC:DEC electrolyte in which 1M LiPF₆ salt has been dissolved (“reference”) and two experimental electrolyte compositions containing CPME in which 1M or 5M LiFSI has been dissolved (“1M LiFSI in CPME” and “5M LiFSI in CPME,” respectively).

FIG. 3B shows room temperature studies conducted with the reference, experimental 1M LiFSI in CPME, and experimental 5M LiFSI in CPME electrolyte compositions of FIG. 3A for cyclability at a 1 C rate.

FIG. 3C shows room temperature studies conducted with the reference, experimental 1M LiFSI in CPME, and experimental 5M LiFSI in CPME electrolyte compositions of FIG. 3A for rate performance.

FIG. 3D shows room temperature studies conducted with the reference and experimental 1M LiFSI in CPME electrolyte compositions of FIG. 3A for cyclability in high active material loaded electrodes.

FIG. 4A shows low temperature performances of a low active mass loaded graphite electrode in the commercial (“reference”) electrolyte of 1M LiPF₆ in 1:1 EC:DEC.

FIGS. 4B and 4C show low temperature performances of a low active mass loaded graphite electrode in an experimental electrolyte of 1M LiFSI in CPME.

FIG. 4D shows the stability of a low active mass loaded graphite electrode in the experimental electrolyte of 1M LiFSI in CPME at −20° C. at 0.1 C rate.

FIGS. 4E and 4F show low temperature performance charge discharge curves and cyclability at 0.1 C rate, respectively, for a high active mass loaded graphite electrode in the commercial (“reference”) electrolyte of 1M LiPF₆ in 1:1 EC:DEC and the experimental electrolyte of 1M LiFSI in CPME.

FIGS. 5A and 5B show EDS spectra measured at different temperatures for the commercial (“reference”) electrolyte of 1M LiPF₆ in 1:1 EC:DEC and the experimental electrolyte of 1M LiFSI in CPME.

FIGS. 5C and 5D show Arrhenius behavior of resistance corresponding to Li⁺ desolvation and resistance related to Li⁺ transport in SEI for the commercial electrolyte (“CE”) of 1M LiPF₆ in 1:1 EC:DEC and the experimental electrolyte of 1M LiFSI in CPME (“CPME”).

FIGS. 5E and 5F show temperature dependent Rct and Rsei values for, respectively, for the commercial (“reference”) electrolyte of 1M LiPF₆ in 1:1 EC:DEC and the experimental electrolyte of 1M LiFSI in CPME.

FIGS. 6A and 6B show deconvoluted XPS spectra of a graphite anode in a delithiated state after 10 cycles for F1s and C1s, respectively, in the commercial (“Conv”) electrolyte of 1M LiPF₆ in 1:1 EC:DEC and the experimental electrolyte of 1M LiFSI in CPME (“CPME”).

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

In investigations leading to the present invention, high concentration electrolytes were evaluated in lithium-ion batteries (LIB) due to the significant film forming ability of the electrolytes. In this disclosure, it is demonstrated that higher concentrations are not always an option for superior performance of an LIB. According to certain aspects of the present invention, an electrolyte composition is provided that comprises a lithium salt (e.g. lithium bifluorosulphonyl imide (LiFSI)) dissolved in cyclopentyl methyl ether (CPME, also known as methoxycyclopentane), an ether-based. Such an electrolyte composition, which is notably and preferably free of any ethylene carbonate (EC), was shown to provide a solvation structure capable of forming a thin robust multilayer solid electrolyte interface (SEI) with an inorganic LiF-rich inner layer and an organic-based outer layer, confirmed by ex-situ XPS analysis. Aggregates and contact ion pairs are actively formed in a solvation shell (sheath) and reduced on the graphite anode during lithiation. Such an EC-free electrolyte composition was shown to provide 86.85% initial efficiency, 356 mAh g⁻¹ over 350 cycles with an excellent capacity retention of 84% at 1 C rate along with superior stability for graphite at room temperature. An excellent low temperature performance of 370 mAh g⁻¹, 337 mAh g⁻¹ and 330 mAh g⁻¹ at 0° C., −10° C. and −20° C. at 0.1 C rate was recorded. Furthermore at −40° C., the graphite half-cell had a capacity of 274 mAh g⁻¹. An electrolyte composition made with 1M CPME demonstrated lower resistance than a commercial electrolyte at −20° C., demonstrating an advancement in designing electrolytes for subzero temperature operations of LIBs.

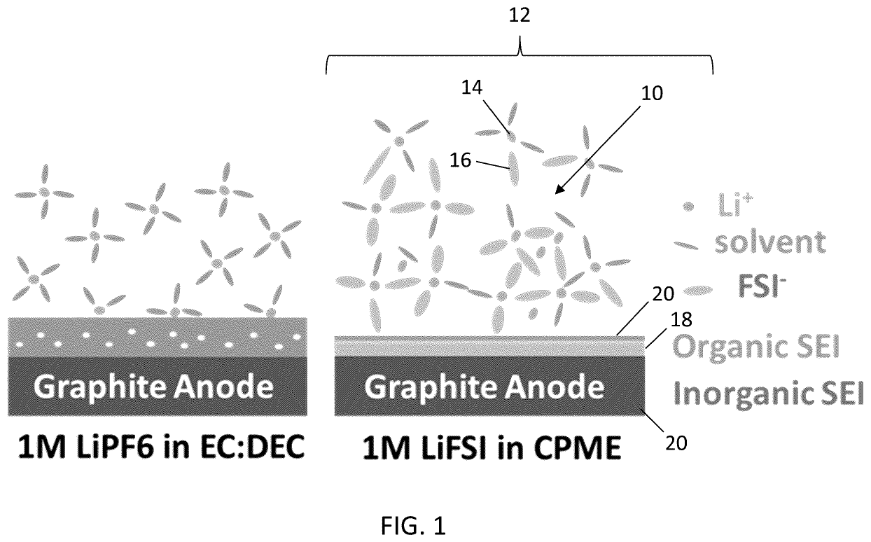

FIG. 1 shows on the left side an anode in an electrochemical cell using a conventional electrolyte composition (1M LiPF₆ in a 1:1 EC:DEC electrolyte), and on the right side an electrochemical cell 12 using an electrolyte composition 10 according to a nonlimiting embodiment of the invention, wherein the electrolyte composition 10 is formed of 1M lithium bifluorosulphonyl imide (LiFSI) dissolved in cyclopentyl methyl ether (CPME) that results in Li cations 14 and FSI anions 16. Preferably, the electrolyte composition 10 does not include ethylene carbonate. The electrolyte composition 10 has an anion-derived solvation structure that reduces covalent bond strength between the Li cations 14 and the FSI anions 16. The electrolyte composition 10 forms an SEI having an inner layer 18 of lithium fluoride (LiF) on an anode 20 of the electrochemical cell. The LiF inner layer 18 is an inorganic layer. The electrolyte composition 10 also forms a thin organic outer layer 22 on the LiF inner layer 18 that covers the inner layer 18. In this manner, the SEI covering the anode 20 has a bi-layer structure formed of the inner inorganic layer 18 of LiF and the organic outer layer 22. The organic outer layer 22 may be formed of or include Li₂C₂O₄, for example. Of course, the electrochemical cell 12 may include other typical components of a typical electrochemical cell suitable for use, for example, as a battery. In addition, the electrolyte composition 10 is not limited to the specific molarity identified in FIG. 1, but may have other forms and molarities, as will become apparent in the following description.

Described hereinafter are materials and methods used in experiments leading to and/or confirming certain characteristics of the present invention. Electrochemical tests were carried out using a half-cell configuration with an anode formed of mesocarbon microbeads (MCMB) and lithium metal foils as a counter electrode and reference electrode. The lithium metal foil and MCMB were purchased from MSE supplies. Lithium bis(fluorosulfonyl)imide (LiFSI) salt was purchased from TCL America. dimethoxyethane (DME), and cyclopentyl methyl ether (CPME) were obtained from Sigma Aldrich. The commercial electrolyte used for comparison was made of 1M LiPF₆ salt in a mixture of 1:1 EC:DEC (ethylene carbonate and diethylene carbonate at 1:1 volume ratio) battery grade from Sigma Aldrich. The electrolytes were prepared by dissolving a selected amount of the salt in solvents in an argon-filled glovebox. High mass loaded MCMB electrodes (6.2-6.3 mg cm⁻²) were made at CAMP facility Argonne National Laboratory.

Structural Characterizations: The coordination structures of solutions were determined by a Raman microscope (Thermo Scientific DXR 2) with a 613 nm laser. The chemical composition on the surface of graphite electrodes were investigated by X-ray photoelectron spectrometer (Kratos AXIS Ultra) equipped with a monochromatized Al-Kα X-ray source. The electrodes were cycled 10 times in the suitable electrolytes for SEI formation and washed with dimethyl carbonate (DMC) in the Argon-filled glove box to remove the residual electrolyte components before the characterization of XPS.

Electrochemical Characterizations: Graphite electrodes were coated onto Cu foils with a mass loading of about 6.2-6.3 mg cm⁻². The graphite electrodes had high mass loadings containing mesocarbon microbeads (MCMB) graphite (91.83 wt. %) as an active material, C45 (2 wt. %) as a conductive agent, polyvinylidene difluoride (PVDF) (6 wt. %) as a binder, and oxalic acid (0.17 wt. %) as an additive. Electrodes with lower loadings were made from blade coating with 80% MCMB powder, 10 wt. % carbon black, and 10 wt. % polyvinylidene fluoride (PVDF) binder. The prepared electrodes had an areal loading of 1.5 mg cm⁻². The electrodes were dried in vacuum oven at 80° C. overnight and cut into 13 mm discs. Half cells were assembled using CR2032 coin-type cells with lithium metal as a counter electrode, a polypropylene membrane (Celgard 2500) as a separator, and the prepared electrolytes in the argon-filled glove box. Half-cell galvanostatic charge/discharge measurements were carried out using a battery-testing system (Arbin BT-2000) at a voltage range of 0.001 to 1.5 V versus Li/Li⁺. Charging (lithiation) and discharging (delithiation) was performed in a constant current mode. To determine cycling stability at room temperature, the half cells were cycled at 0.5 C-rate (1 C=372 mA g⁻¹). For low temperature performance tests, the half cells were charged and discharged with the following C-rate at several temperatures (0.1 C for 0° C., −10° C., −20° C., and 0.005° C. for-40° C.). The formation cycles were given for the cells at 0.1 C-rate for 5 cycles before all cycling tests. Rate capability tests were carried out with different current rates (0.2 C to 2 C) at room temperature. EIS were performed over a frequency range of 1 MHz to 50 mHz with 10 mV amplitude of AC voltage perturbation at several temperatures (25 to −20° C.). Before EIS, the half cells were cycled at 0.1 C for 1 cycle between 1.5 V and 0.001 V.

In investigations leading to this invention, the ether-based CPME electrolyte solvent was shown to exhibit superior stability and ultralow temperature performance at temperature of as low as −40° C. The solvent exhibited an excellent film-forming ability that avoided the need for EC and other high concentration approaches. The improved characteristics were demonstrated by comparing a 1M LiPF₆ in EC:DEC (1:1) electrolyte (also referred to herein as a “reference” electrolyte or a “commercial electrolyte” (“CE”)) with a 1M LiFSI in CPME (also referred to as 1M CPME herein) and a 5M LiFSI in CPME (also referred to as 5M CPME herein) in Li/Graphite coin cells. The CPME-containing electrolyte compositions exhibited a unique solvation structure that contains contact ion pairs (CIPs) and cation and anion aggregates (AGGs) in its solvation shell (sheath) even in a diluted state (e.g., 1M). The CPME solvent has suitable physical properties required for low temperature functioning of LIBs, as examples, a high boiling point (106° C.), an ultralow melting point (−140° C.), and a lower dielectric constant, while also having a high solubility for salt (7M). The CPME solvent is an environmentally-safe green solvent commercially available and economically feasible to synthesis. Compared to other ether solvents, the CPME solvent does not form peroxide even if exposed to the air atmosphere for several days. The CPME solvent is a solvent used in organic chemistry but not yet reported as being even considered for use in battery applications. The 1M CPME delivered a high capacity of 351 mAh g⁻¹ at 1 C (372 mAh g⁻¹) and very good stability up to 350 cycles with 84% capacity retention at room temperature. The capacity remains the same until −20° C. with 100% retention at −20° C. Even at −40° C., the 1M CPME electrolyte composition gives a capacity of 274 mAh g⁻¹. Detailed analysis was carried out using Raman, XPS, and electrochemical methods and the results are summarized below.

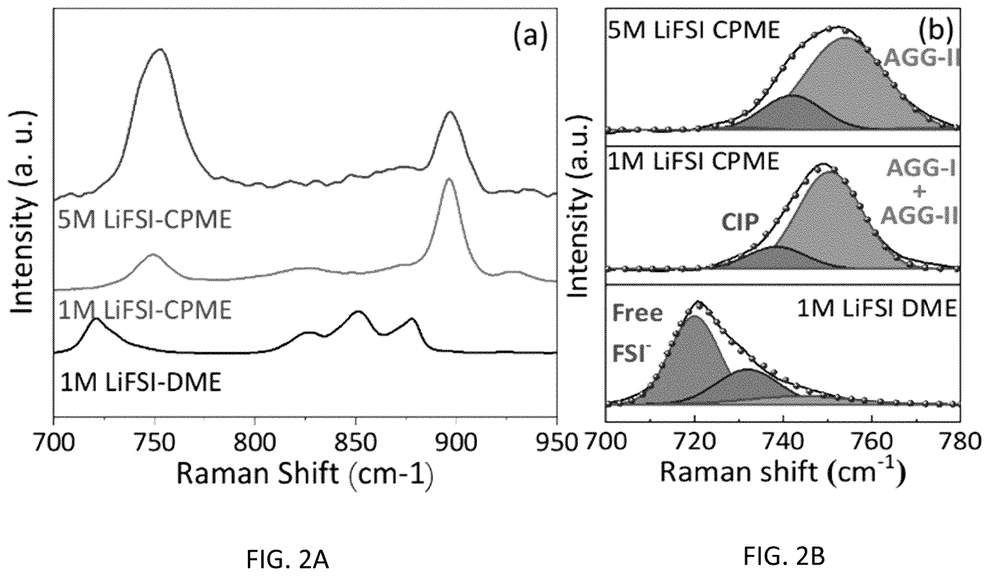

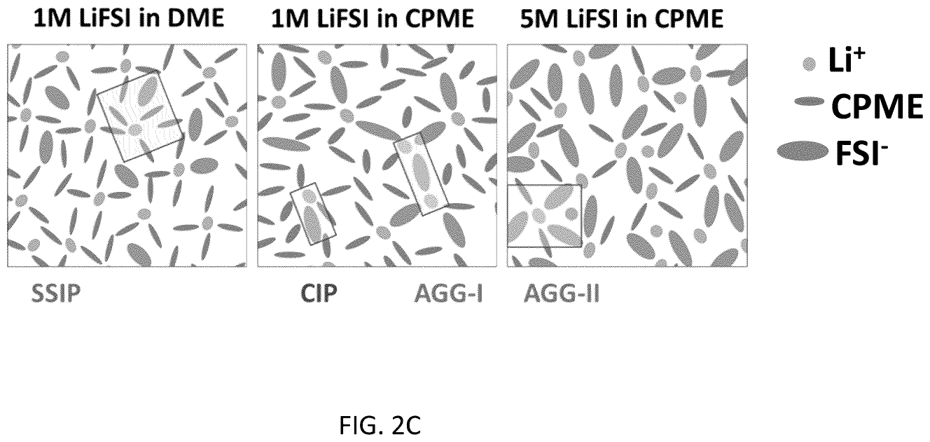

Solvation structure: Raman spectra were obtained to visualize the solvation structure of 1M LiFSI in DME, 1M LiFSI in CPME, and 5M LiFSI in CPME electrolyte compositions. The intent of using a diluted electrolyte of DME was to differentiate the unique solvation structure of a diluted CPME electrolyte composition with that of common ethers. FIG. 2A shows the overall spectrum including both anion and solvent molecules. The peaks between 700 cm⁻¹ and 775 cm⁻¹ belongs to FSI⁻ anions, whereas the peaks above 800 cm⁻¹ denotes DME and CPME solvents, respectively. For 1M LiFSI in DME, the peaks at 825, 850 and 875 cm⁻¹ denote the free solvent molecules with CH₂ oscillation and C—O stretching behavior. In the 1M and 5M CPME electrolyte compositions, the peaks at 820 and 895 cm⁻¹ denoted free CPME solvent molecules. Initial observation of CPME clearly shows that the peak intensity of solvent decreases with increasing salt concentration. In 5M CPME by increasing the salt ratio more solvents were brought inside solvation structure leaving only lesser free solvent molecules. CPME can dissolve a very high salt concentration of up to 7 M of LiFSI, which was significantly higher for a weakly solvated electrolyte composition. The deconvoluted peaks of FSI⁻ anion is provided in FIG. 2B. Three different states of FSI⁻ anion were clearly distinguished as free FSI⁻, contact ion pair (CIP), and aggregates. These are schematically represented in FIG. 2C. Free FSI are those without involving in solvation structure, CIP represents single anion attached to single Li⁺, and aggregates denotes single anion attached to two or more Li⁺. Diluted DME electrolyte was dominated by free FSI⁻ anions, which are not available for SEI formation, while the CPME electrolyte compositions had CIP and AGG and its major influence in SEI formation. A notable aspect of CPME lies in its increased AGG ratio with respect to CIP structures. This was different than that of reported works, in which the CIP dominates. The peak around 750 cm⁻¹ for CPME corresponds to two different aggregate structures. AGG-I represents single FSI⁻ anion bonded with two Li⁺ ion, whereas in AGG-II, FSI-anion forms bond with three Li⁺. Previous studies could achieve similar in Li metal work by using an additional diluting solvent, however, which adds more complexity. The solvation structure of the present disclosure remains unique like that of high concentration salts even in diluted state and first reported for graphite anode.

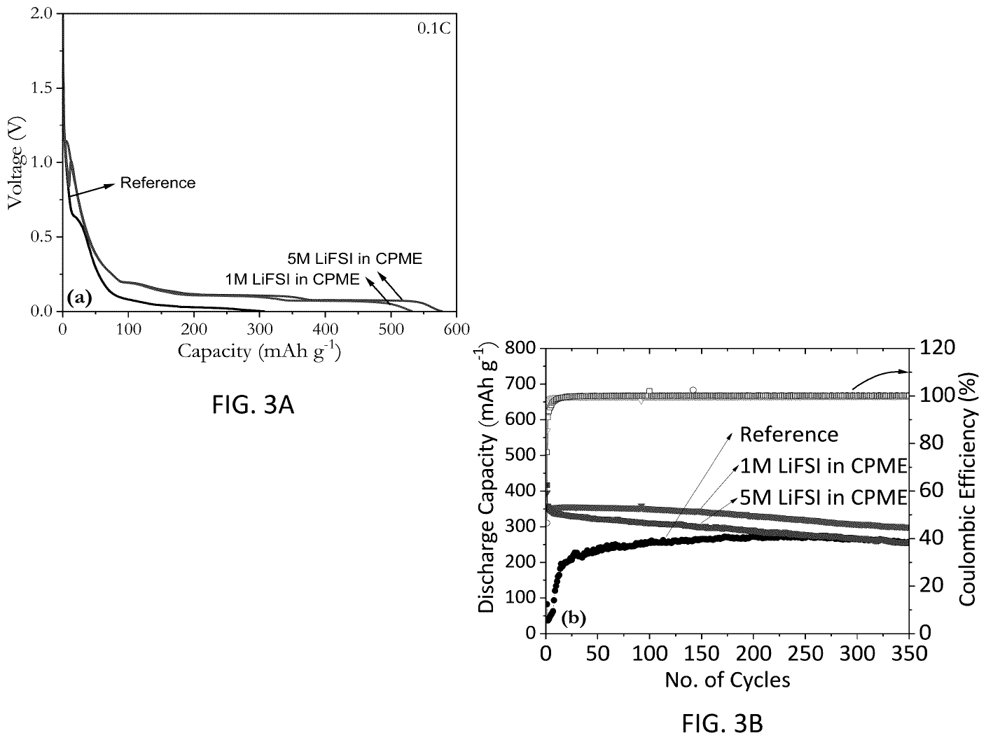

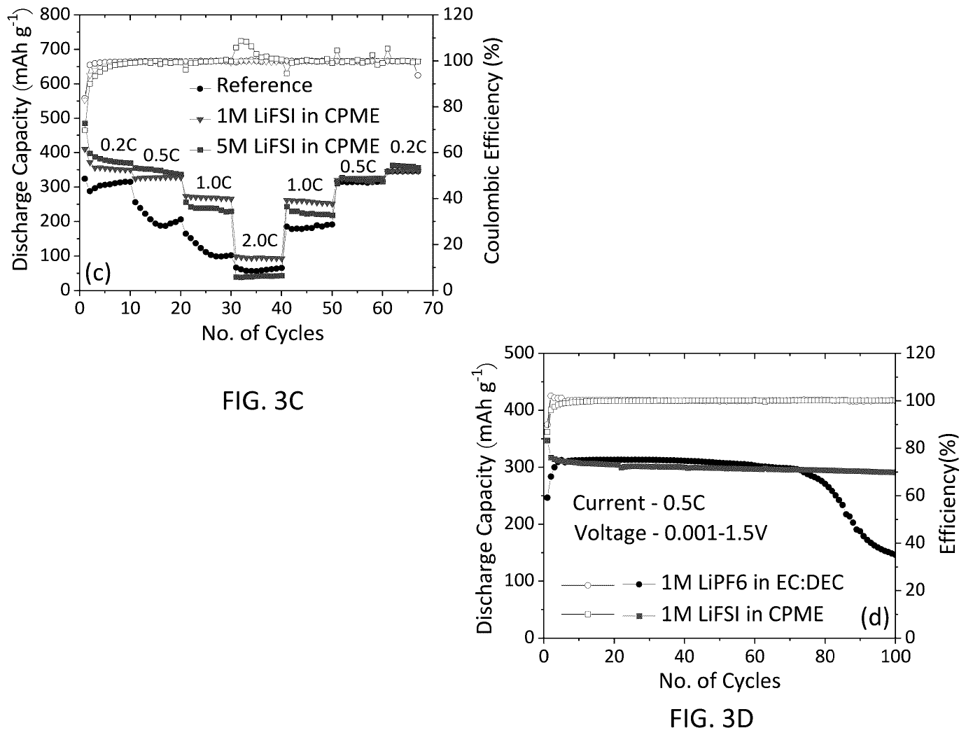

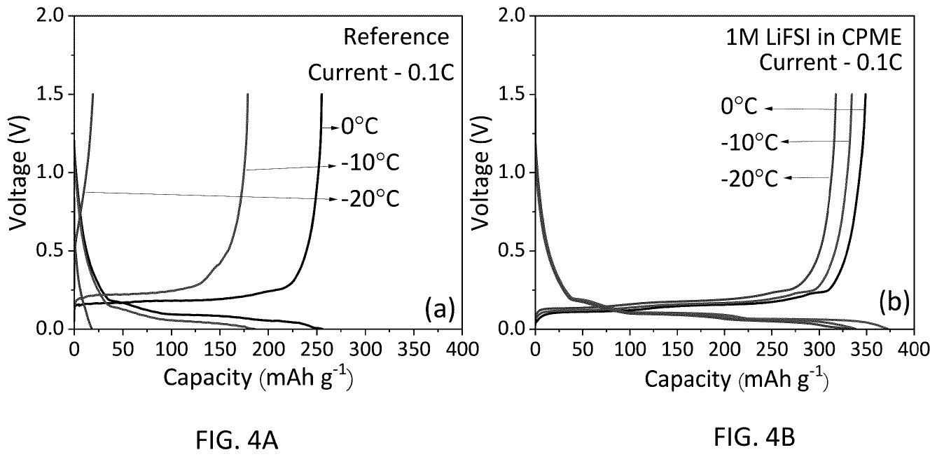

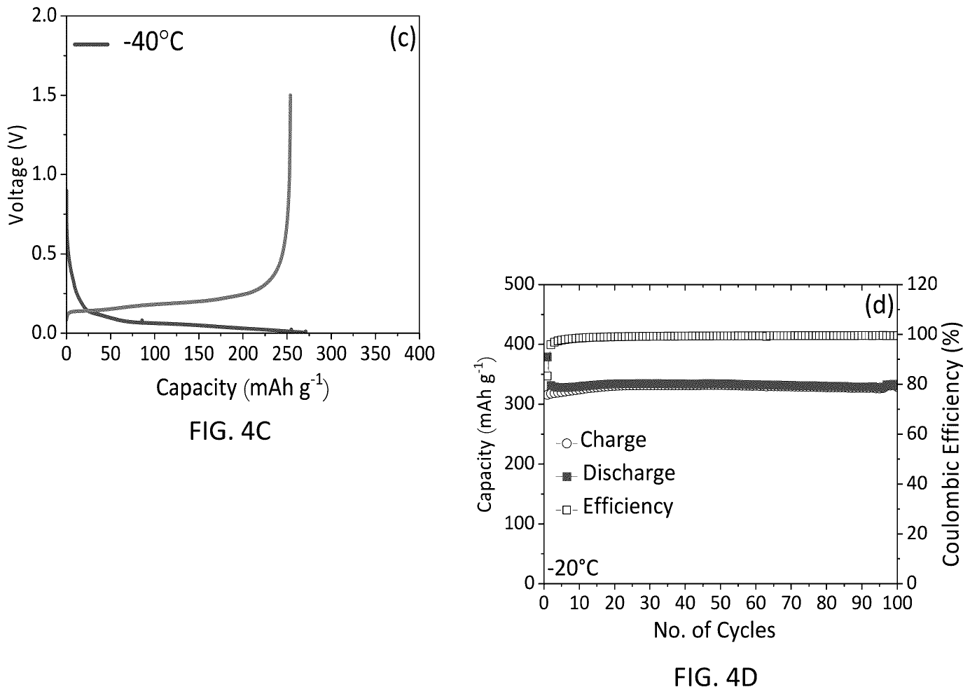

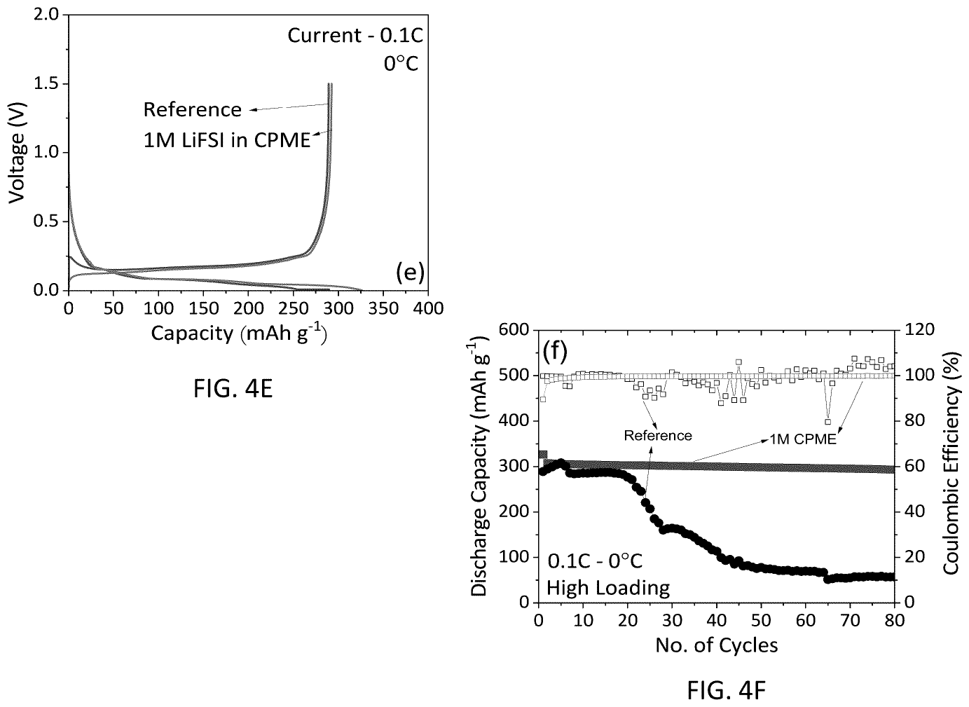

Room Temperature Electrochemical Performance: FIGS. 3A and 3D show a comparison of the electrochemical performance of graphite anodes with a 1M CPME electrolyte composition and a 5M CPME electrolyte composition in accordance with aspects of the present invention, as compared with a commercial electrolyte in a graphite/Li⁺ half-cell. The detailed experimental information is described above. The electrochemical performance was carried out using two different electrode configurations with high active mass loading (6.2 mg cm⁻²) and low active mass loading (1.5 mg cm⁻²). The discharge capacity-voltage curves obtained at 0.1 C for low active mass loading are shown in FIG. 4A. During initial lithiation of the graphite anode, a clear peak appears for CPME electrolyte compositions at 1 V and 1.14 V corresponding to the reduction of electrolytes with anion-derived solvation structure on the graphite surface. The absence of this peak in the following cycle gives a clear picture of stable SEI layer formation in the first cycle. This was followed by continuous lithiation of graphite resulting in LiC₆ at the end of discharge. In contrast, the commercial electrolyte decomposed at a lower voltage of 0.6 V, forming a thick SEI layer. Further, the room temperature cyclability of these electrodes was evaluated at 1 C (372 mAh g⁻¹) rate up to 350 cycles within 1.5 to 0.001V voltage window. The 1M CPME electrolyte composition had a higher first cycle coulombic efficiency of 85.29% higher than the 5M CPME electrolyte composition and CE electrolyte composition with a value of 76.37 and 46.55%, respectively. The initial discharge capacity for the CE, the 1M CPME, and the 5M CPME were 82 mAh g⁻¹, 395.625 mAh g⁻¹ and 416.892 mAh g⁻¹. The reversible capacity obtained from these electrolyte compositions was 82 mAh g⁻¹, 355 mAh g⁻¹ and 356 mAh g⁻¹, respectively. After 100 cycles, these two CPME electrolyte compositions could still maintain a higher retention of 98.80% and 86.57%. Even after 350 cycles, the two CPME electrolyte compositions had a capacity of 298.72 mAh g⁻¹ and 254.675 mAh g⁻¹ retaining 84.13% and 71.37% capacity. Throughout cycling, the coulombic efficiency remains 100% due to the better compatibility of the CPME electrolyte compositions with the graphite anode. The commercial electrolyte starts with a low capacity of 82 mAh g⁻¹ and gradually increase with the cycling until it reaches a maximum capacity of 270 mAh g⁻¹ and gradually decrease to 256.33 mAh g⁻¹ after 350 cycles and starts degrading. This may be due to the formation of an unstable and porous SEI layer composed of dominant Li₂CO₃ and small LiF initially and stabilized over cycling. This SEI had electron donating nature and created a favorable situation for continuous reduction of electrolytes, resulting in capacity degradation over cycling. In contrast, the 1M CPME formed a robust thin SEI layer made of LiF-rich content and a small amount of Li₂C₂O₄ even at 1 C rate. This unique SEI layer with LiF was more favorable for faster Li⁺ ion conduction along its grain boundaries, vacancies, defects with reduced charge transfer resistance. The 5M LiFSI in CPME electrolyte composition forms a slightly thicker LiF-rich SEI layer that consumes more Li⁺ during initial cycle followed by its increased resistance for ion movement. This was evident from the slightly lower capacity retention after prolonged cycling. Overall, these were so far the best cyclability data of graphite anode in a diluted ether electrolyte without any cosolvents, additives and ethylene carbonate. The cycling of these electrolytes at different current rates is provided in FIG. 3C. At lower a C-rate of 0.2 C, the capacity of CPME was similar and higher than the commercial electrolyte. At a higher C-rate, the 1M CPME electrolyte composition had a higher capacity of 98.45 mAh g⁻¹, possibly due to lower charge transfer resistance and favorable ionic conductivity at the interface. The 5M CPME electrolyte composition had the lowest capacity of 39.17 mAh g⁻¹, possibly due to its higher viscosity and higher charge transfer resistance. By considering the practical feasibility of this electrolyte, high areal loading electrodes were used, the results of which are represented in FIG. 3D. The cyclability was tested at 0.5 C rate between 0.001 V and 1.5 V till 100 cycles. The initial performance of graphite with CE and CPME had a capacity of 246.68 mAh g⁻¹ and 347.05 mAh g⁻¹. First cycle corresponds to formation of an SEI layer in the CPME electrolyte composition, whereas CE forms a porous organic SEI layer which gets stabilized over cycles as seen from capacity increase to 283.51 mAh g⁻¹. The initial Coulombic efficiency for CPME had a higher value of 86.85%, the highest reported for an ether-based electrolyte. After 100 cycles, the 1M CPME electrolyte composition had a highest retention of 91.77%, while CE could only maintain 51.62%.

Subzero temperature battery cycling studies: An electrolyte composition according to some aspects of the invention preferably has superior subzero temperature operation. The electrochemical performance of an commercial EC/DEC electrolyte was compared to a diluted CPME electrolyte composition according to aspects of the present invention using less active material loaded graphite electrodes from 0° C. to −40° C. and the results are displayed in FIGS. 4A-4F. The 1M CPME electrolyte composition could deliver highest capacities of 370 mAh g⁻¹, 337 mAh g⁻¹ and 331 mAh g⁻¹ with respect to 0° C., −10° C. and −20° C. at 0.1 C rate between 0.001 to 1.5V. Further at −20° C., it retains 100% of its capacity until 50 cycles at 0.1 C rate. This was by far the highest reported capacity for graphite anode at −20° C. Going down to −40° C., the 1M CPME electrolyte composition could still work without freezing and provide a capacity of 273 mAh g⁻¹ at 0.005 C. In comparison, the performance of the commercial electrolyte-based cell was not as good as it could only retain half the theoretical capacity of 183 mAh g⁻¹ at −10° C. and almost stopped working with only 20 mAh g⁻¹ at −20° C. This improved performance of the CPME electrolyte composition of the present invention at ultralow temperature may be due to the very low freezing point (−140° C.) of the CPME solvent along with the thin, robust, and inorganic LiF-rich SEI layer. Similarly, the high loaded electrodes were tested at 0° C. using the commercial electrolyte and the diluted CPME electrolyte composition at 0.1 C rate as shown in FIGS. 4E and 4F. It had a 1^{st} cycle capacity of 289 mAh g⁻¹ and 326 mAh g⁻¹ and retains 56.9 mAh g⁻¹ and 293.24 mAh g⁻¹ after 80 cycles with a retention of 20% and 90%. The initial coulombic efficiency was 99.83% for carbonate electrolyte and a very high value of 89.5% for diluted CPME electrolyte composition.

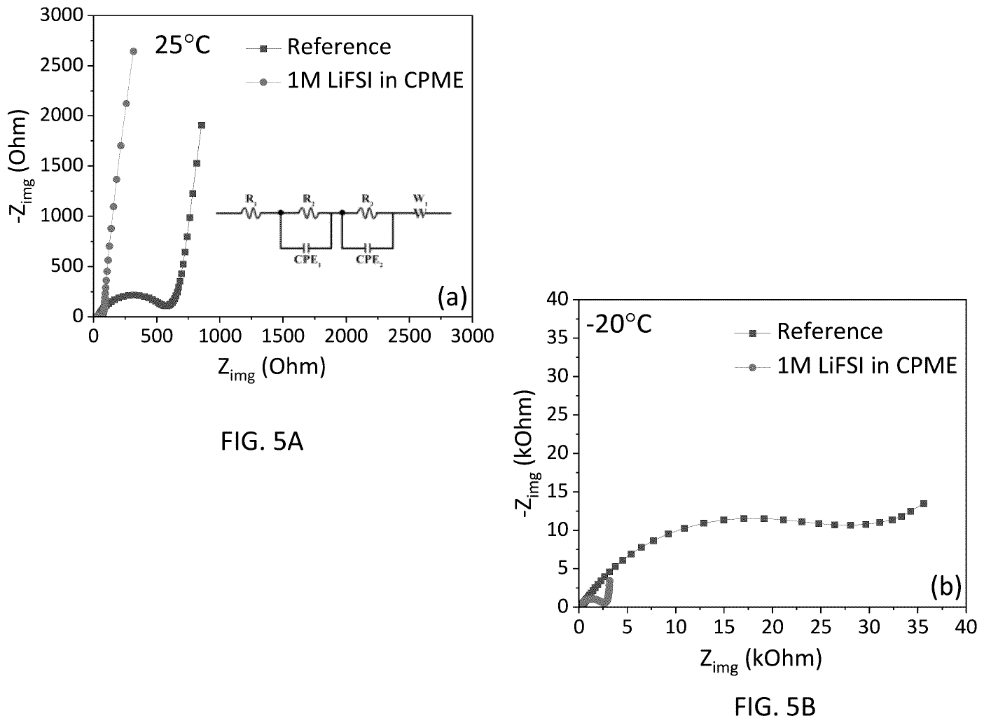

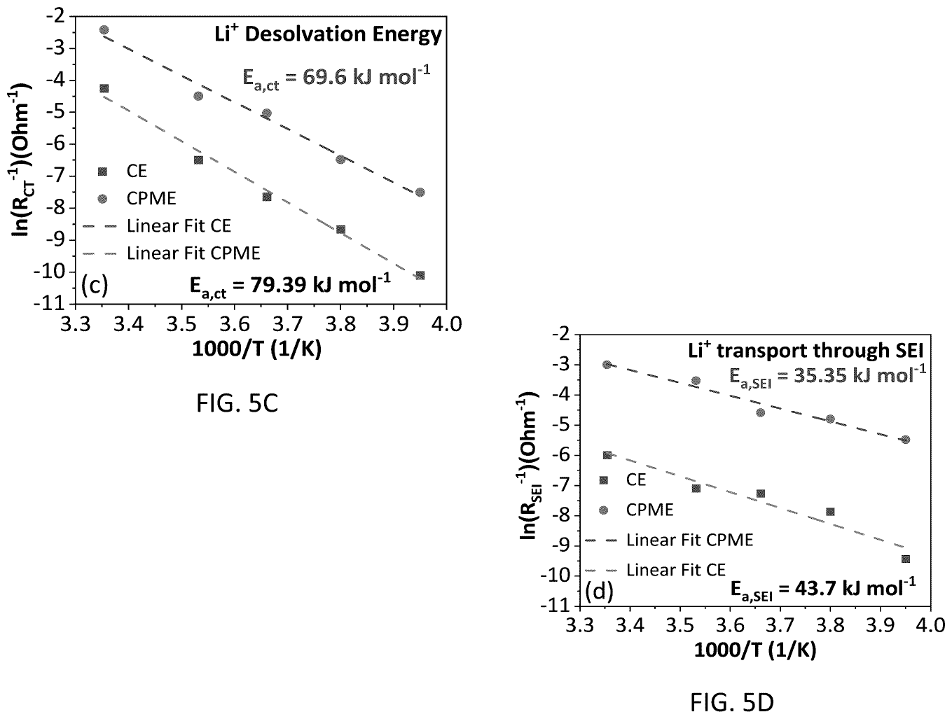

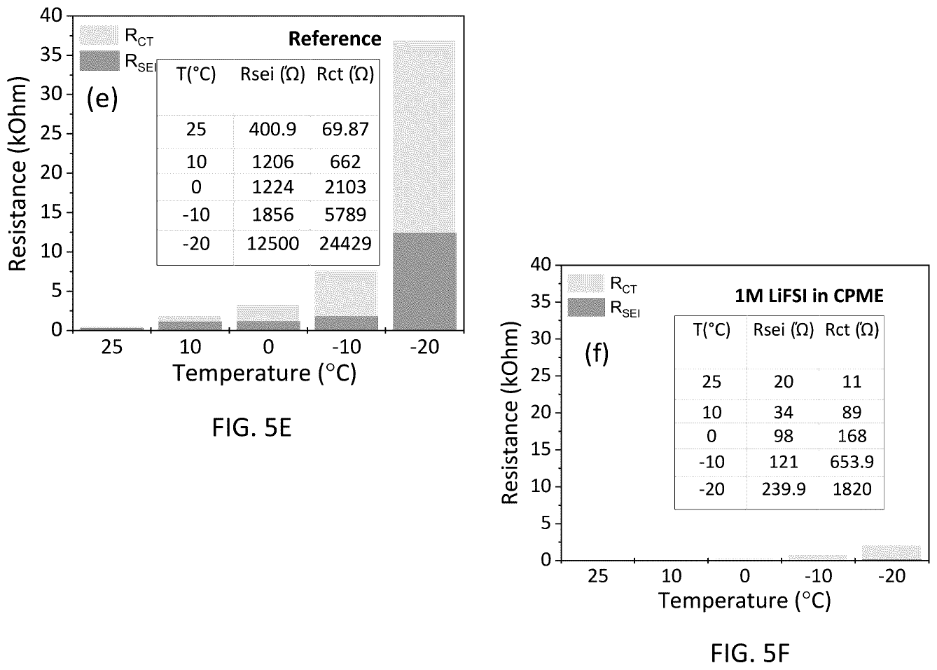

Impedance is an important tool to quantify the nature of the interfaces and its influence on the electrochemical performance. FIGS. 5A-5F show the EIS spectra of the commercial electrolyte and the 1M CPME electrolyte composition with an applied frequency of 100 kHz to 0.05 Hz from an AC signal of 5 mV. The spectrum can be divided into four different parts like Ohmic resistance, SEI resistance and charge transfer resistance followed by Warburg diffusion. The curves were fitted using equivalent circuit and the resistance values are provided in insets of FIGS. 5E and 5F. The overall resistance values increase with the decrease in temperature. The Ohmic resistance was seen at high frequency region, where the curve intersects the X axis. This includes the intrinsic properties of the electrolytes and electrodes like conductivity etc. The SEI and charge transfer resistance are provided by the semicircle at the medium frequency region and results from the resistance of the SEI and other interfaces. This value was very much reduced for diluted CPME in the order of 10-fold than the commercial electrolyte as expected from the robust and thin LiF film formed from the reduction of anion-derived unique solvation structure during initial lithiation. Many reports are available to represent the importance of LiF SEI layer as it has an improved Young's modulus and better stability over cycling. Even though it has poor ionic conductivity, the coexistence of different inorganic and organic species creates defects, grain boundaries, and local charges, thereby creating an efficient pathway for ion hopping and migration. This was confirmed by calculating the activation energies at interfaces by using Arrhenius law with respect to various temperatures as shown in FIGS. 5C and 5D. The diluted CPME electrolyte composition had the lower desolvation energy (69.6 kJ mol⁻¹) as compared to that of the commercial EC/DEC electrolyte (79.39 kJ mol⁻¹) because in this the desolvation was primarily due to dissociation of ion pairs (Li⁺-FSI⁻) and aggregates (3Li⁺-FSI⁻) than Li⁺-solvent molecules. Further Li⁺ transport through SEI layer had lower energy for CPME electrolyte composition due to abundant grain boundaries, defects and hopping sites, while the Li⁺ diffusion in porous inorganic SEI of carbonate electrolytes are more energy consuming. Further, the Rct and Rsei values obtained from fitting the Nyquist plot using equivalent circuits for the commercial electrolyte and diluted CPME electrolyte composition at different temperatures are provided in FIGS. 5E and 5F. The values of the CPME electrolyte composition were much reduced and negligible in comparison with the commercial electrolyte.

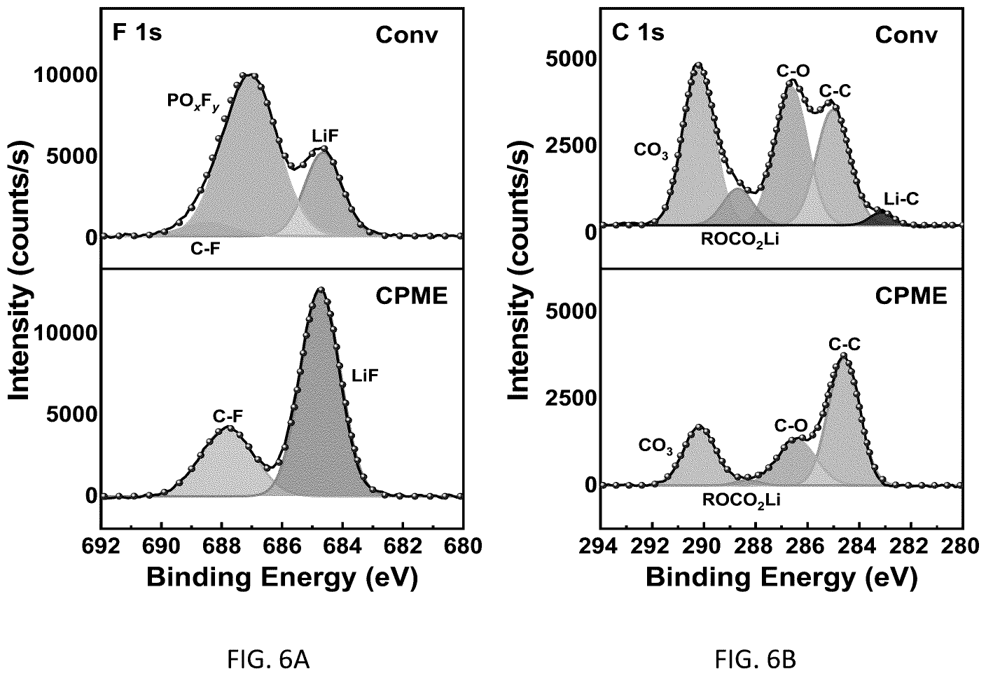

SEI layer Analysis: To have a better understanding of the SEI formation mechanism and its composition, XPS analysis was carried out on delithiated graphite electrode after 10 cycles at 0.1 C rate in the commercial and 1M CPME electrolyte compositions. FIGS. 6A and 6B represent the deconvoluted XPS spectra of F1s and C1s elements on the graphite surface after cycling in commercially available 1M LiPF₆ in EC/DEC electrolyte and the experimental 1M LiFSI in CPME. The F1s spectra can be divided into 3 different peaks representing C—F (687.7 eV), POₓF_{y} (687.06 eV), and LiF (684.58 eV). The intensity of POₓF_{y}-based porous organic specious was higher than the LiF peak in the commercial electrolyte resulting from continuous reduction of LiPF₆ over cycling. In contrast, the CPME electrolyte composition had a higher content of LiF, whereas POₓF_{y} peak had completely disappeared in the spectra. This can be explained as there was no LiPF₆-based side reaction in the CPME solvent. The predominance of LiF peak was due to the reduction of FSI⁻ anions from AGG and CIP solvation structures. C—F represents PVDF binder, which had intensity variations due to the thickness of the SEI layer formed. The C1s spectra had four major partitions with CO₃ (290.2 eV), ROCO₂Li (288.6 eV), C—O (286.6 eV), C—C(284.74 eV) respectively. The CO₃ represents Li₂CO₃-based solvent-derived SEI component, which had been significantly reduced for the CPME electrolyte composition. This was believed to be because anions from solvation structure reduce initially on anode surface and forms stable LiF-rich SEI layer, preventing further reduction of solvent molecules. ROCO₂Li and C—O correspond to an organic species available as an outer layer of SEI with LiF as the inner layer. Thickness of the SEI layer formed was inferred from C—C bond intensity of graphite anode. Higher intensity was due to thin SEI layer and vice versa. Based on the above results, a schematic illustration of SEI formation is provided in FIG. 1, as discussed previously.

In view of the above, a CPME electrolyte composition was capable of providing an EC-free electrolyte highly suitable for use in low temperatures (e.g., from 0° C. to at least −40° C., and possibly lower) and fast charging applications with its unique anion-derived SEI layer that includes an LiF inner layer disposed directly on the graphite anode. The results provide a new way to achieve the SEI composition without approaching the costly and complex high concentration route. Cyclopentyl methyl ether as a green solvent has a wide liquid temperature range and low dielectric constant suitable for scaleup and commercialization without any modification in the manufacturing structure. The results are impressive with high capacity of 331 mAh g⁻¹ at 0.1 C and 100% stability at −20 C and could reach up to −40 C. The bilayer structure of solid electrolyte interface (inorganic LiF-rich inner core and thin outer organic layer) as confirmed from XPS analysis helps in overcoming the main bottleneck of highest desolvation energy.

Further in view of the above, some aspects of the disclosure include an electrolyte composition (for use in an electrochemical cell) containing LiFSI (lithium bifluorosulphonyl imide) dissolved in CPME. The electrolyte preferably has an anion-derived solvation structure reducing the covalent bond strength between the Li cations and FSI anions, resulting in an LiF layer on anode of the electrochemical cell. In some embodiments, the thickness of the LiF layer on the anode is in the range of 2-5 nm. In some embodiments, the activation energy barrier for transport of Li⁺ ions to the anode from the electrolyte such as 1M LiFSI in CPME is in the range of 35.35 kJ mol⁻¹ to 43.7 kJ mol⁻¹. In some embodiments, the concentration of LiFSI in CPME is in the range of about 1M to about 5M, and preferably in the range of about 0.9 M to about 1.1 M. The 1M CPME electrolyte composition according to some embodiments forms a robust thin SEI layer made of LiF-rich content and a small amount of Li₂C₂O₄ even at 1 C rate. This unique SEI layer with LiF was more favorable for faster Li⁺ ion conduction along its grain boundaries, vacancies, defects with reduced charge transfer resistance. 1M CPME electrolyte composition could deliver highest capacities of 370 mAh g⁻¹, 337 mAh g⁻¹ and 331 mAh g⁻¹ with respect to 0° C., −10° C. and −20° C. at 0.1 C rate between 0.001 to 1.5V. Further at −20° C., it retains 100% of its capacity until 100 cycles at 0.1 C rate. This was by far the highest reported capacity for graphite anode at −20° C. Going down to −40° C., the electrolyte could still work without freezing and provide a capacity of 273 mAh g⁻¹ at 0.005 C. The performance of the commercial electrolyte-based cell was poor in comparison as it could only retain half the theoretical capacity of 183 mAh g⁻¹ at −10° C. and almost stopped working with only 20 mAh g⁻¹ at −20° C. This extraordinary performance at ultralow temperature was believed to be due to the very low freezing point (−140° C.) of the CPME solvent along with the thin, robust, and inorganic LiF-rich SEI layer. 1M LiFSI in CPME was shown to have highest capacity and better stability at low temperature due to its superior ionic conductivity. In some embodiments, the conductivity of the electrolyte may be 0.497, 0.392, 0.305, 0.194, 0.127 and 0.093 milliSiemen/cm at 40° C., 25° C., 10° C., −10° C., −30° C. and −40° C., respectively. In some embodiments, the conductivity of the electrolyte may be in the range of 0.1 to 1.0 mS/cm.

Other aspects of the disclosure include an electrochemical cell containing an anode, a cathode, a separator (e.g., Celgard or polypropylene), and an electrolyte comprising LiFSI (lithium bifluorosulphonyl imide dissolved in CPME. The electrolyte preferably has an anion-derived solvation structure reducing the covalent bond strength between the Li cations and FSI anions. In some embodiments, the concentration of LiFSI in CPME may be about 1M to about 5M. In some embodiments, the concentration of LiFSI in CPME may be 0.9M to 1.1 M. In some embodiments, the conductivity of the electrolyte may be 0.497, 0.392, 0.305, 0.194, 0.127 and 0.093 milliSiemens/cm at 40° C., 25° C., 10° C., −10° C., −30° C., and −40° C. respectively. In some embodiments, the conductivity of the electrolyte is in the range of 0.05 mS to 0.6 mS. In some embodiments, the anode may be one or more of graphite, Li₅Ti₄O₁₂, and Li metal. In some embodiments, the cathode is LiFePO₄. In some embodiments, the separator may be made of polypropylene.

In some embodiments, the wetting angle between the electrolyte and separator may be in the range of 30° C.-35° C. The lower the wetting angle, the better the efficiency of electrolyte utilization will be.

In some embodiments, the discharge capacity of the anode is in the range of 350 mAh g⁻¹ to 356 mAh g⁻¹ in a temperature range of 20° C.-25° C. In some embodiments, there is an LiF layer on the anode wherein the thickness of the LiF layer on the anode is in the range of 2-5 nm.

As previously noted above, though the foregoing detailed description describes certain aspects of one or more particular embodiments of the invention, alternatives could be adopted by one skilled in the art. it will be apparent to those of ordinary skill in the art that other embodiments and implementations are possible that are within the scope of the present disclosure without departing from the spirit and scope of the present disclosure. As such, and again as was previously noted, it should be understood that the invention is not necessarily limited to any particular embodiment described herein or illustrated in the drawings.

1. An electrochemical cell comprising:
an anode, a cathode, and a separator therebetween; and
an electrolyte composition contacting the anode, the cathode, and the separator, the electrolyte composition comprising lithium bifluorosulphonyl imide (LiFSI) dissolved in CPME that forms Li cations and FSI anions;
wherein the electrolyte composition has an anion-derived solvation structure that reduces covalent bond strength between the Li cations and FSI anions.

2. The electrochemical cell of claim 1, wherein the LiFSI has a concentration in the CPME of about 1M to about 5M, and the electrolyte composition does not comprise ethylene carbonate.

3. The electrochemical cell of claim 1, wherein the LiFSI has a concentration in the CPME of 0.9M to 5M.

4. The electrochemical cell of claim 1, wherein the electrolyte composition has conductivity of 0.497, 0.392, 0.305, 0.194, 0.127 and 0.093 milli Siemens/cm at 40° C., 25° C., 10° C., −10° C., −30° C., and −40° C., respectively.

5. The electrochemical cell of claim 1, wherein the electrolyte composition has conductivity in the range of 0.05 mS to 0.6 mS.

6. The electrochemical cell of claim 1, wherein the anode comprises one or more of graphite, Li₅Ti₄O₁₂, and Li metal.

7. The electrochemical cell of claim 1, wherein the cathode comprises one or more of LifePO₄, LiCoO₂, and LiMn₂O₄.

8. The electrochemical cell of claim 1, wherein a wetting angle between the electrolyte composition and the separator is in the range of 30° C. to 35° C.

9. The electrochemical cell of claim 1, wherein the anode has a discharge capacity in the range of 350 mAh g⁻¹ to 356 mAh g⁻¹ in a temperature range of 20° C. to 25° C.

10. The electrochemical cell of claim 1, further comprising a LiF layer disposed on the anode, wherein the LiF layer has a thickness in the range of 2 nm to 5 nm.

11. The electrochemical cell of claim 10, further comprising an organic outer layer formed by the electrolyte composition and disposed on the LiF layer.

12. The electrochemical cell of claim 11, wherein the organic outer layer comprises Li₂C₂O₄.

13. The electrochemical cell of claim 1, wherein the separator comprises polypropylene.

14. An electrolyte composition for an electrochemical cell, the electrolyte composition comprising:
lithium bifluorosulphonyl imide (LiFSI) dissolved in cyclopentyl methyl ether (CPME) resulting in Li cations and FSI anions;
wherein the electrolyte composition has an anion-derived solvation structure that reduces covalent bond strength between the Li cations and FSI anions; and
wherein the electrolyte composition forms a lithium fluoride (LiF) layer on an anode of an electrochemical cell.

15. The electrolyte composition of claim 14, wherein the electrolyte composition does not include ethylene carbonate.

16. The electrolyte composition of claim 14, wherein the LiFSI has a concentration in the CPME of about 1M to about 5M.

17. The electrolyte composition of claim 14, wherein the electrolyte composition has conductivity of 0.497, 0.392, 0.305, 0.194, 0.127 and 0.093 milli Siemens/cm at 40° C., 25° C., 10° C., −10° C., −30° C., and −40° C., respectively.

18. The electrolyte composition of claim 14, wherein the electrolyte composition has conductivity in the range of 0.05 mS/cm to 1.0 mS/cm.

19. The electrolyte composition of claim 14 in an electrochemical cell having an anode and comprising a lithium fluoride (LiF) layer disposed on the anode, wherein the LiF layer has a thickness is in the range of 2 nm to 5 nm.

20. The electrolyte composition of claim 19, wherein the electrochemical cell has an activation energy barrier for transport of the Li ions to the anode from the electrolyte composition of 35.35 kJ mol⁻¹ to 43.7 kJ mol⁻¹.
